(19) United States
(12) Patent Application Publication
(10) Pub. No.: US 2016/0085921 A1
(43) Pub. Date: Mar. 24, 2016

(54) CONFIGURING ACCESSIBILITY SETTINGS FOLLOWING A MEDICAL CHANGE

(71) Applicant: International Business Machines Corporation, Armonk, NY (US)

(72) Inventors: Robert G. Farrell, Cornwall, NY (US); Sharon M. Trewin, Croton-on-Hudson, NY (US)

(21) Appl. No.: 14/971,399

(22) Filed: Dec. 16, 2015

Related U.S. Application Data
(63) Continuation of application No. 14/304,314, filed on Jun. 13, 2014.

(51) Int. Cl. G06F 19/00

(52) U.S. Cl. CPC G06F 19/322

(57) ABSTRACT

In an approach to configuring accessibility settings on an electronic device, a computer receives a first electronic data including at least one medical change made to an electronic medical record corresponding to a user. The computer determines at least one accessibility settings recommendation for an electronic device of the user. The computer receives a unique identifier of the user. The computer sends a second electronic data comprising the at least one accessibility settings recommendation to the electronic device of the user. The computer determines current accessibility settings of the electronic device. The computer calculates a difference between the current accessibility settings and the at least one accessibility settings recommendation. The computer determines whether the difference meets a target value. If the difference does not meet a target value, the computer configures the electronic device with the at least one accessibility settings recommendation. The computer queries the user for acceptance.

### BACKGROUND OF THE INVENTION

The present invention relates generally to the field of accessibility, and more particularly to configuring device settings for accessibility.

There are a number of challenges facing users with medical conditions that prevent them from fully experiencing the benefits of the personal computer (PC) and other devices. Many medical conditions can affect the ease with which users can adapt their interaction methods, working style, modes of communication, and thought processes to fit the device or software they are using. The aging population faces challenges similar to those faced by users with medical conditions, such as difficulty seeing the display, hearing the audio, using the mouse, and configuring their system. As the design of information technology systems and applications develops, more and more features allowing electronic devices to be configured to suit a range of user preferences and requirements are included.

While users who develop medical conditions are likely to have the most extreme demands, there are many other users that may benefit from accessibility options because of the various factors that can produce temporary or situational disabilities. For example, a user may have a temporary disability due to an injury. The user may be able to type with only one hand and therefore require an alternative way to generate multiple key presses such as Control-Alt-Delete. Other users may have difficulties that are situational (e.g. due to fatigue, or background noise).

### SUMMARY

According to one embodiment of the present invention, a method for configuring accessibility settings on an electronic device is provided. The method for configuring accessibility settings on an electronic device may include a computer receiving a first electronic data including at least one medical change made to an electronic medical record corresponding to a user. The computer determines at least one accessibility settings recommendation for an electronic device of the user. The computer receives a unique identifier of the user. The computer sends a second electronic data comprising the at least one accessibility settings recommendation to the electronic device of the user. The computer determines current accessibility settings of the electronic device. The computer calculates a difference between the current accessibility settings and the at least one accessibility settings recommendation. The computer determines whether the difference meets a target value. If the difference does not meet a target value, the computer configures the electronic device with the at least one accessibility settings recommendation. The computer queries the user for acceptance. Responsive to receiving an acceptance of the query from the user, the computer maintains the at least one accessibility setting recommendation configuration.

### BRIEF DESCRIPTION OF THE SEVERAL VIEWS OF THE DRAWINGS

FIG. 1 is a functional block diagram illustrating a distributed data processing environment, in accordance with an embodiment of the present invention;

FIG. 2 is a flowchart depicting operational steps of a settings recommendation program, on a server computer within the distributed data processing environment of FIG. 1, for determining recommended device settings based on a medical change, in accordance with an embodiment of the present invention;

FIG. 3 is a flowchart depicting operational steps of a health accessibility configuration program, inserted on a client computing device within the distributed data processing environment of FIG. 1, for configuring the client computing device with recommended settings, in accordance with an embodiment of the present invention; and

FIG. 4 depicts a block diagram of components of the server computer and the client computing device within the distributed data processing environment of FIG. 1, in accordance with an embodiment of the present invention.

### DETAILED DESCRIPTION

People who develop certain medical conditions may develop associated physical characteristics that impact their use of electronic devices. Many such devices include options that come under the heading of “universal access” or “accessibility”, designed to allow a user to manually change the user interface of the device to match the user's requirements. Many users are unaware of the alternative configurations that may enable them to use their device more easily and effectively. Users also may not know which options may help or how to adjust the options for the physical characteristics impacting their device usage.

Embodiments of the present invention recognize that user accessibility may be improved if, following a medical change or diagnosis, adjustments to the accessibility options of electronic devices are initiated automatically, and confirmed with little or no user effort. Implementation of embodiments of the invention may take a variety of forms, and exemplary implementation details are discussed subsequently with reference to the Figures.

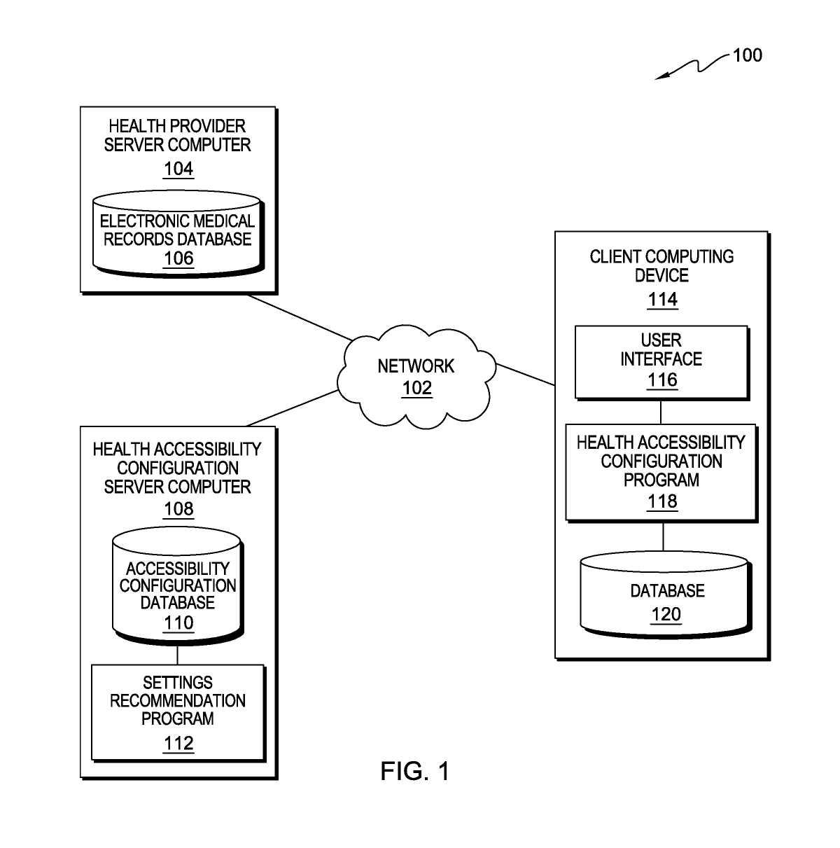

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes health provider server computer 104, health accessibility configuration server computer 108, and client computing device 114. Health accessibility configuration server computer 108, and client computing device 114 are interconnected over network 102. Network 102 can be, for example, a telecommunications network, a local area network (LAN), a wide area network (WAN), such as the Internet, or a combination of the three, and can include wired, wireless, or fiber optic connections. Network 102 may include one or more wired and/or wireless networks that are capable of receiving and transmitting data, voice, and/or video signals, including multimedia signals that include voice, data, and video information.

Health provider server computer 104 is a computing device that may be a management server, a web server, or any other electronic device or computing system capable of receiving and sending data. In other embodiments, health provider server computer 104 may represent a server computing system utilizing multiple computers as a server system, such as in a cloud computing environment. In another embodiment, health provider server computer 104 may be a laptop computer, a tablet computer, a netbook computer, a personal computer (PC), a desktop computer, a personal digital assistant (PDA), a smart phone, or any programmable electronic device capable of communicating with health accessibility configuration server computer 108. In another embodiment, health provider server computer 104 represents a computing system utilizing clustered computers and components to act as a single pool of seamless resources. In an embodiment, health provider server computer 104 includes electronic health records software. Health provider server computer 104 utilizes authentication based on a unique identifier, such as a user ID, in order to prevent sharing of electronic medical records with an unauthorized user of health accessibility configuration server computer 108. In one embodiment, the user ID is generated by software running on health provider server computer 104. The user ID may be stored elsewhere in the environment, for example, in a directory server accessible to both health provider server computer 104 and health accessibility configuration server computer 108. In one embodiment, a health professional creates the user ID and provides the user ID to a user. In another embodiment a user creates the user ID and provides the user ID to a health professional. Health provider server computer 104 includes electronic medical records database 106. Various methods are available by which the user receives credentials for accessing medical records in electronic medical records database 106.

Electronic medical records database 106 resides on health provider server computer 104. In another embodiment, electronic medical records database 106 may reside on health accessibility configuration server computer 108, or elsewhere in the environment. A database is an organized collection of data. Electronic medical records database 106 can be implemented with any type of storage device capable of storing data that may be accessed and utilized by health provider server computer 104, such as a database server, a hard disk drive, or a flash memory. In other embodiments, electronic medical records database 106 can represent multiple storage devices within health provider server computer 104. Electronic medical records database 106 stores electronic health information, such as electronic health records (EHR), also known as electronic medical records (EMR). An EMR may include information about a patient's active diseases, including infectious, metabolic, and genetic diseases, such as diabetes, Parkinson's disease, macular degeneration, autism, etc. An EMR may also contain values for a patient's human health parameters (e.g. visual acuity) and physical characteristics (e.g. age, height, weight). Other types of health data stored in electronic medical records database 106 may reflect information received from medical devices, home monitoring devices, smart phone health applications, or mobile applications for health and wellness (e.g. dieting and weight loss, fitness and strength training, eye care, medical adherence, stress management, chronic disease management, and pregnancy self-care). When a medical professional determines a diagnosis of a medical condition or disease, the diagnosis may be recorded in the patient's EMR. Each disease may have a disease code. For example, a disease code for Type-II Diabetes mellitus in the International Classification of Diseases version 2010 (ICD-10) code is E11, though medical conditions may be identified that have no standardized disease code. In addition, when a medical professional prescribes a medication, the medication may be recorded in the patient's EMR. Also, when a medical test is performed, values for health parameters may be recorded in the patient's EMR. Health, medical, and wellness information potentially impacting the accessibility of computing devices may come from a variety of professionals, systems, services, and applications. Electronic medical records database 106 also stores the user IDs discussed above. In another embodiment, the association between user IDs and electronic medical records is stored elsewhere on health provider server computer 104 or elsewhere in the environment.

Health accessibility configuration server computer 108 is a computing device that may be a management server, a web server, or any other electronic device or computing system capable of receiving and sending data. In other embodiments, health accessibility configuration server computer 108 may represent a server computing system utilizing multiple computers as a server system, such as in a cloud computing environment. In another embodiment, health accessibility configuration server computer 108 may be a laptop computer, a tablet computer, a netbook computer, a personal computer (PC), a desktop computer, a personal digital assistant (PDA), a smart phone, or any programmable electronic device capable of communicating with health provider server computer 104 and client computing device 114. In another embodiment, health accessibility configuration server computer 108 represents a computing system utilizing clustered computers and components to act as a single pool of seamless resources. Health accessibility configuration server computer 108 includes accessibility configuration database 110 and settings recommendation program 112. In one embodiment, both health accessibility configuration server computer 108 and health provider server computer 104 are standalone server computers connected via a secure network, such as an intranet, in order to protect the privacy of electronic medical records. In another embodiment, health accessibility configuration server computer 108 and health provider server computer 104 are integrated together into one server computer. Health accessibility configuration server computer 108 utilizes authentication based on both the user ID, discussed with respect to health provider server computer 104, and a configuration ID. The configuration ID is a unique identifier that associates a user of health accessibility configuration server computer 108 with a user of client computing device 114 in order to maintain the privacy of the medical information of the user of client computing device 114. The user ID is only communicated between health provider server computer 104 and health accessibility configuration server computer 108. The user ID serves as authentication credentials between health provider server computer 104 and health accessibility configuration server computer 108. Additional credentials, such as a password, can be provided along with the user ID. Many authentication mechanisms are possible, as may be appreciated by one skilled in the art. The electronic medical record may be encrypted in health provider server computer 104 and decrypted in health accessibility configuration server computer 108 upon receipt. Accessibility settings may be encrypted at health accessibility configuration server computer 108 and decrypted at client computing device 114. Many encryption schemes are possible (e.g. RSA public key encryption).

Accessibility configuration database 110 resides on health accessibility configuration server computer 108. In another embodiment, accessibility configuration database 110 may reside on health provider server computer 104, or elsewhere in the environment. A database is an organized collection of data. Accessibility configuration database 110 can be implemented with any type of storage device capable of storing data that may be accessed and utilized by health accessibility configuration server computer 108, such as a database server, a hard disk drive, or a flash memory. In other embodiments, accessibility configuration database 110 can represent multiple storage devices within health accessibility configuration server computer 108. Accessibility configuration database 110 stores potential changes to physical characteristics associated with medical conditions and diagnoses. For example, diabetes is known to cause weight gain, which, in turn, may cause an increase in finger size. In another example, autism is known to be associated with increased sensitivity to contrast. Accessibility configuration database 110 also stores the user IDs of the user of client computing device 114 and the associated configuration IDs of the user of client computing device 114 discussed above.

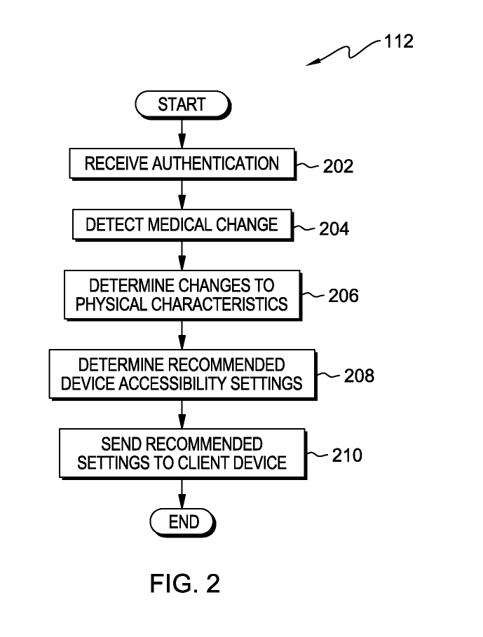

Settings recommendation program 112 determines the recommended device settings based on a medical change or diagnosis which may improve or optimize the user's ability to use an electronic device. Settings recommendation program 112 receives credentials, including the configuration ID, from a user of a client computing device, such as client computing device 114, in distributed data processing environment 100, retrieves the user ID associated with the configuration ID from accessibility configuration database 110, and retrieves medical data corresponding to the authenticated user from electronic medical records database 106 on health provider server computer 104. Settings recommendation program 112 utilizes the user's retrieved medical data to compute potential changes to the user's physical characteristics. Settings recommendation program 112 updates the physical characteristics of the user stored in accessibility configuration database 110, and determines the recommended settings for client computing device 114. Settings recommendation program 112 sends the recommended settings to client computing device 114. A plurality of accessibility parameters for electronic devices exists, including: zoom level, font size, color scheme, contrast level, key repeat delay, and video subtitles. Settings recommendation program 112 is depicted and described in further detail with respect to FIG. 2.

Client computing device 114 may be a desktop computer, a laptop computer, a tablet computer, a specialized computer server, a smart phone, a kiosk, a home or car controller with a touch screen, or any programmable electronic device capable of communicating with health accessibility configuration server computer 108 via network 102 and with various components and devices within distributed data processing environment 100. Client computing device 114 may be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In general, client computing device 114 represents any programmable electronic device or combination of programmable electronic devices capable of executing machine readable program instructions and communicating with other computing devices via a network, such as network 102. Client computing device 114 includes user interface 116, health accessibility configuration program 118, and database 120.

User interface 116 is a program that provides an interface between a user of client computing device 114 and a plurality of applications that reside on client computing device 114 (not shown). A user interface, such as user interface 116, refers to the information (such as graphic, text, and sound) that a program presents to a user and the control sequences the user employs to control the program. There are many known types of user interfaces. In one embodiment, user interface 116 is a graphical user interface. A graphical user interface (GUI) is a type of user interface that allows users to interact with electronic devices, such as a computer keyboard and a mouse, through graphical icons and visual indicators, such as secondary notation. The actions in GUIs are often performed through direct manipulation of the graphical elements. User interface 116 receives setting configurations from health accessibility configuration program 118.

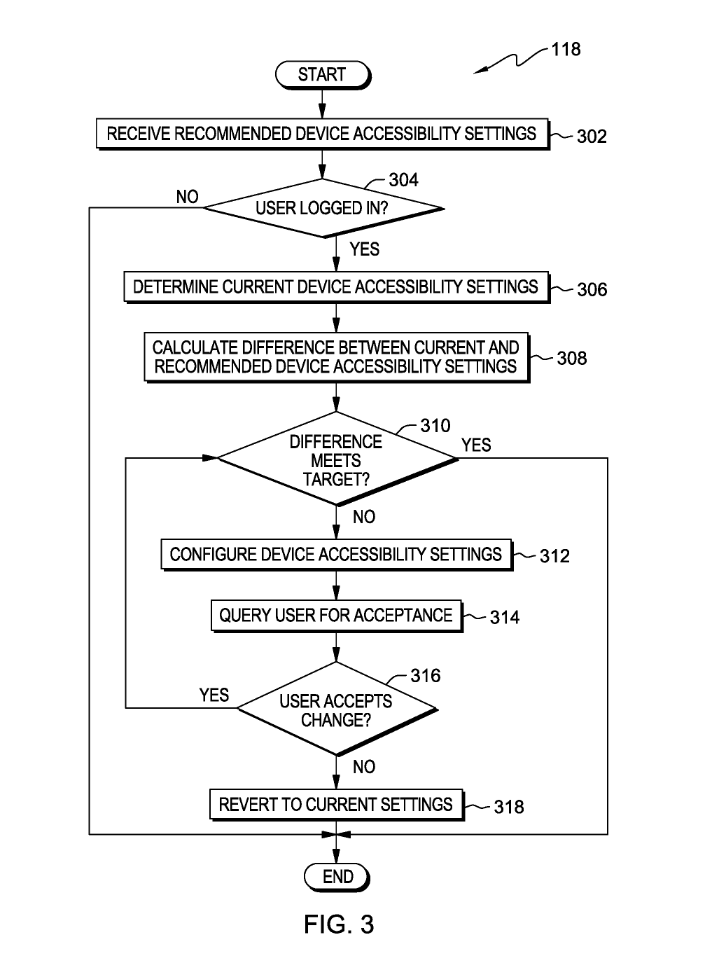

Health accessibility configuration program 118 resides on client computing device 114. Health accessibility configuration program 118 may be installed on client computing device 114 or health accessibility configuration program 118 may be integrated into the operating system software of client computing device 114. In another embodiment, health accessibility configuration program 118 may reside on health accessibility configuration server computer 108. Health accessibility configuration program 118 configures user interface 116 of client computing device 114 with recommended accessibility settings received from settings recommendation program 112. A user may download health accessibility configuration program 118 to client computing device 114 at the request of a health care provider that may share electronic medical records with the user. Upon initialization of health accessibility configuration program 118, health accessibility configuration program 118 generates a configuration ID associated with the user's device login ID. In one embodiment, the login ID is associated with the user's log in password for the device. In another embodiment, the login ID may be associated with a biometric attribute, such as a fingerprint or voice recognition. Subsequent to the user receiving the configuration ID, the user logs in to health accessibility configuration server computer 108, through settings recommendation program 112, with the user's configuration ID. After login, the user registers both the configuration ID and the network address of client computing device 114. The network address allows settings recommendation program 112 to find client computing device 114 on network 102. Health accessibility configuration program 118 determines whether received settings from settings recommendation program 112 differ from the current settings of user interface 116. If the current settings do not meet a target value, health accessibility configuration program 118 incrementally changes the settings with the user's approval. Health accessibility configuration program 118 is depicted and described in further detail with respect to FIG. 3.

Database 120 resides on client computing device 114. A database is an organized collection of data. Database 120 can be implemented with any type of storage device capable of storing data that may be accessed and utilized by client computing device 114, such as a database server, a hard disk drive, or a flash memory. In other embodiments, database 120 can represent multiple storage devices within client computing device 114. Database 120 stores the configuration ID, discussed above. Database 120 also stores the login ID belonging to the user of client computing device 114. Database 120 may also store device accessibility settings and configurations.

In an embodiment, a diagnosis stored in electronic medical records database 106 after a user visit to a doctor triggers a request to settings recommendation program 112 to update the accessibility configuration for the user with the diagnosis. The user has a user ID enabling access to both medical records on health provider server computer 104 and accessibility settings on health accessibility configuration server 108. Settings recommendation program 112 retrieves the electronic medical record, looks up the configuration IDs for that user ID in accessibility configuration database 110, and computes a new device configuration for each of these devices, such as client computing device 114. Subsequently, the user logs in, using the login ID to client computing device 114, triggering health accessibility program 118 to look up the configuration ID associated with the login ID in database 120. Health accessibility program 118 sends a request to health accessibility configuration server computer 108, over network 102, to determine if there are any changes to the accessibility settings of the configuration ID. When there are changes in accessibility configuration database 110 since the last request, settings recommendation program 112 returns the new accessibility settings to health accessibility program 118, and health accessibility program 118 updates user interface 116 with the new settings.

FIG. 2 is a flowchart depicting operational steps of settings recommendation program 112, on health accessibility configuration server computer 108 within distributed data processing environment 100 of FIG. 1, for determining recommended device settings based on a medical change, in accordance with an embodiment of the present invention.

Settings recommendation program 112 receives authentication (step 202). In one embodiment, the addition of a diagnosis to an EMR may trigger settings recommendation program 112 to begin. In this embodiment, settings recommendation program 112 receives authentication from health provider server computer 104 via the user ID. In another embodiment, the user of client computing device 114 triggers settings recommendation program 112 to begin by initiating a request. In this embodiment, settings recommendation program 112 receives authentication from the user when the user inputs the configuration ID. A user request may also be the result of a system request. For example, when a user starts up client computing device 114, health accessibility configuration program 118 may automatically send a request to settings recommendation program 112. Settings recommendation program 112 utilizes authentication to prevent sharing of private medical information with unauthorized users. For example, if client computing device 114 is a laptop shared by several family members, the use of unique identifiers associated with each family member prevents one family member from inadvertently receiving a private medical diagnosis of another family member.

Settings recommendation program 112 detects a medical change (step 204). In one embodiment, settings recommendation program 112 continually monitors EMRs for electronic data that indicates changes in medical records of users with the corresponding user IDs. Based on the user ID, settings recommendation program 112 detects a medical change by receiving new electronic medical data from electronic medical records database 106 on health provider server computer 104. For example, settings recommendation program 112 may detect the diagnosis of Parkinson's disease. In another example, settings recommendation program 112 may detect a prescription for a medication with associated side effects. Settings recommendation program 112 may also detect new medical data from the results of laboratory tests. For example, as a result of a diagnosis of macular degeneration, a lab test for visual acuity may be performed, and the results of the lab test may be stored in electronic medical records database 106. In another embodiment, settings recommendation program 112 detects a medical change based on a request from a program, a user, or a medical professional. For example, a user receives a diagnosis of diabetes and sends a request, based on the medical change, to settings recommendation program 112. Responsive to receiving the request, settings recommendation program 112 retrieves health data that may be related to the medical diagnosis from electronic medical records database 106.

Settings recommendation program 112 determines changes to physical characteristics of the user (step 206). Settings recommendation program 112 retrieves data from accessibility configuration database 110 to determine whether any changes to physical characteristics are associated with the detected medical change or diagnosis. There are several circumstances that may indicate changes to physical characteristics, such as a medical diagnosis, changes in the values of health parameters, or measurements of physical characteristics. For example, a diagnosis of macular degeneration is associated with a reduction of visual acuity. In another example, a diagnosis of diabetes is associated with an increase in body weight. In a further example, a medical change due to an injury, such as head trauma resulting from boxing, is associated with blurry vision. Settings recommendation program 112 may also determine changes to physical characteristics through direct measurement, or by user entry. For example, a user may record a change in weight. Other methods may be used to determine potential changes in physical characteristics given the medical diagnosis. Examples of physical characteristics include, but are not limited to, use of limbs, finger size, manual dexterity, locomotion, speaking, hearing, balance, visual acuity, contrast sensitivity, peripheral field of view, and human memory.

Settings recommendation program 112 determines recommended device accessibility settings (step 208). For example, Parkinson's disease increases movement initiation time as it advances. On a standard computer keyboard, a key that is held down starts to generate repeated characters after a certain time delay. A user with Parkinson's disease may find it difficult or impossible to raise a finger off the key before this delay is up. As a result, the user may generate many unwanted repeated characters, making accurate typing difficult. Settings recommendation program 112 determines an appropriate configuration of the key repeat delay value to reduce or eliminate unwanted key repeats, enabling accurate typing for the user. In one embodiment, settings recommendation program 112 may determine an appropriate configuration of the key repeat delay value by reviewing the user's historical key delay information and increasing the delay time incrementally until the user's typing is more accurate. In another embodiment, settings recommendation program 112 may determine an appropriate configuration of the key repeat delay value based on historical studies performed on users with Parkinson's disease stored in accessibility configuration database 110. In another example, settings recommendation program 112 determines the settings to increase spacing between targets on a touch screen user interface associated with a diagnosis of diabetes and the associated increase in finger size due to weight gain. The current finger size, if not provided in the medical data retrieved from database 106, may be estimated based on population norms, such as finger size for people with the same height, weight, etc. The increase in finger size is computed based on historical data indicating certain changes in finger size given the type, severity, and length of the diagnosed disease. The increase in target spacing may be proportional to the increase in finger size, with default spacing increasing proportionally to increasing finger size. In a further example, settings recommendation program 112 determines the settings to decrease contrast on an electronic device display associated with a diagnosis of autism. In one embodiment, settings recommendation program 112 utilizes statistical models, for example, Bayesian networks, to enable determining a probable value for a physical characteristic. As both health care providers and users may update medical data, accessibility parameters and settings are continually updated.

Settings recommendation program 112 sends the recommended settings to client computing device 114 (step 210). Responsive to determining the recommended settings associated with the medical change or diagnosis, settings recommendation program 112 sends electronic data that includes the recommended settings to the client computing device associated with the received configuration ID, for example, client computing device 114. Settings recommendation program 112 makes the recommendation of device accessibility settings to the user such that the user's experience with the electronic device may be optimized for the user's medical condition.

FIG. 3 is a flowchart depicting operational steps of health accessibility configuration program 118, inserted on client computing device 114 within distributed data processing environment 100 of FIG. 1, for configuring client computing device 114 with recommended settings, in accordance with an embodiment of the present invention.

Health accessibility configuration program 118 receives recommended device accessibility settings (step 302). When settings recommendation program 112 sends the recommended device accessibility settings to client computing device 114, health accessibility configuration program 118 receives the settings. In some embodiments, the settings are stored in database 120.

Health accessibility configuration program 118 determines if a user is logged in (decision block 304). Each user of client computing device 114 may have a login ID. Health accessibility configuration program 118 determines if the received settings are for a particular user login ID. A configuration ID may be applicable to a single login ID or to multiple login IDs if a user has more than one login ID on a given device. A configuration ID may be stored with multiple client computing devices to synchronize the recommended accessibility settings across the devices. When the user is logged in with a login ID and inputs, generates, or receives a configuration ID, an association between the login ID and configuration ID is added to database 120 so that any changes made to user interface 116 by health accessibility configuration program 118 are associated with the correct, authorized user of client computing device 114. If health accessibility configuration program 118 determines that the user associated with the received accessibility settings is not logged in (no branch, decision block 304), then health accessibility configuration program 118 ends.

If health accessibility configuration program 118 determines that the user of client computing device 114 associated with the received device accessibility settings is logged in (yes branch, decision block 304), then health accessibility configuration program 118 determines the current device accessibility settings (step 306). For example, if the received device accessibility settings refer to font size, health accessibility configuration program 118 determines the current font size used by user interface 116. In another example, if the received device accessibility settings refer to key repeat delay, health accessibility configuration program 118 determines the current setting for key repeat delay. Device accessibility configurations may include aspects of user interface 116 under the control of the operating system of the client computing device 114 or applications running on client computing device 114. Device accessibility configurations may include text and graphics styles, colors, and other aspects of appearance, target placement (e.g. where interaction components such as buttons and menus are placed), size, and other aspects controlling gestural interaction, volume, pitch, and other aspects of speech and sound. Device accessibility configurations can also include information about changes in device settings that have been made in the past, and suggested configuration changes that were not accepted by the user.

Health accessibility configuration program 118 calculates the difference between the current and recommended device accessibility settings (step 308). For example, if the user is diagnosed with glaucoma, then health accessibility configuration program 118 receives a recommended font size of 18 pt from settings recommendation program 112, per step 302. Health accessibility configuration program 118 determines the current font size used by user interface 116 is 16 pt, per step 306. Health accessibility configuration program 118 calculates the difference between 16 pt and 18 pt, i.e. 2 pt.

Health accessibility configuration program 118 determines whether the difference between the current and recommended device accessibility settings meets a pre-defined target value (decision block 310). In one embodiment, the target value for the device accessibility setting difference is a discrete number. In another embodiment, the target value for the device accessibility setting difference is a threshold range. If the difference between the current and recommended device accessibility settings meets the target value (yes branch, decision block 310), then health accessibility configuration program 118 ends. For example, if the target value for the difference between the current font size and the recommended font size is zero, and the current font size is the same as the recommended font size, then health accessibility configuration program 118 ends.

If the difference between the current and recommended device accessibility settings does not meet the target value (no branch, decision block 310), then health accessibility configuration program 118 configures the device accessibility settings (step 312). In one embodiment, health accessibility configuration program 118 configures the device accessibility settings to match the recommended device accessibility settings. In another embodiment, health accessibility configuration program 118 configures the device accessibility settings incrementally. For example, if the difference between the current font size and the recommended font size is 4 pt, an immediate change to the recommended settings may be uncomfortable for the user. Health accessibility configuration program 118 may configure the font size to an intermediate setting to give the user an opportunity to become accustomed to the change. In one embodiment, the intermediate setting may be determined by taking the median value between the current setting and the recommended setting. In another embodiment, the user may choose an intermediate setting via a prompt. In yet another embodiment, intermediate settings may be pre-defined by a system administrator. In one embodiment, changes are only made if the user has not rejected the same suggestion in the recent past, for example, within the past week. The user, through user interface 116, may manually control some accessibility settings. Health accessibility configuration program 118 may coordinate manual changes by the user with automatic changes made by health accessibility program 118. In an embodiment, client computing device 114 may include hardware for changing a user interface. The operating system of client computing device 114 may provide a means of updating user interface 116 with, for example, device drivers or an accessibility programming interface. Health accessibility configuration program 118 may utilize the accessibility programming interface to change user interface 116. In other embodiments, health accessibility configuration program 118 may modify the user interfaces of particular applications running on the operating system of client computing device 114. Health accessibility configuration program 118 may provide additional information to the user regarding the modification to user interface 106, such as displaying the change in health status or physical characteristics that prompted the modification.

In another embodiment, if health accessibility configuration program 118 determines that the user associated with the received accessibility settings is not logged in (no branch, decision block 304), then health accessibility configuration program 118 may check for a valid user and proceed through steps 306 through 312. Subsequently, when the user logs in, health accessibility configuration program 118 retrieves the accessibility settings configuration.

Health accessibility configuration program 118 queries the user for acceptance of the new configuration (step 314). Responsive to configuring the device accessibility settings, health accessibility configuration program 118 queries the user to determine whether the user is satisfied with the new settings. In one embodiment, health accessibility configuration program 118 queries the user by displaying a text box. For example, health accessibility configuration program 118 may display a text box with text that reads “Does this look better? On your keyboard, press 1 for yes or 2 for no.” In another embodiment, health accessibility configuration program 118 may query the user by playing a sound clip and using voice recognition. For example, health accessibility configuration program 118 may play a sound clip that asks “Does this look better? Answer yes or no.” In another embodiment, other methods, for example, tray icons, banners, popup messages, etc. may be used to query the user. In some embodiments, if the user interaction needed to approve the new configuration may be disruptive to the ongoing activities of the user, then health accessibility configuration program 118 updates the configuration in the background. Querying of the user can be scheduled for certain times or linked to certain operations of the device. For example, the user interaction may start when the device reboots, or the user logs in. In another embodiment, health accessibility configuration program 118 configures device accessibility settings automatically and does not request user acceptance.

Health accessibility configuration program 118 determines whether the user accepts the change (decision block 316). If the user does not accept the change (no branch, decision block 316), then device accessibility settings revert back to the current settings (step 318), and health accessibility configuration program 118 ends. If the user accepts the change (yes branch, decision block 316), then health accessibility configuration program 118 returns to step 310 to determine whether the difference between the current and recommended device accessibility settings meets the target value. In an embodiment where health accessibility configuration program 118 configures the changes incrementally, the return to step 310 allows health accessibility configuration program 118 to make another incremental change. In one embodiment, a time delay is associated with the return to step 310. For example, health accessibility configuration program 118 may wait 24 hours before attempting to re-configure the device accessibility settings. This sequence continues until the difference between the current and recommended device accessibility settings meets the target value (yes branch, decision block 310), or until the user chooses not to accept the change. In one embodiment, health accessibility configuration program 118 sends the acceptance or rejection of the change to settings recommendation program 112, via network 102, for purposes of machine learning and updating data in accessibility configuration database 110, as well as improving the operation of settings recommendation program 112.

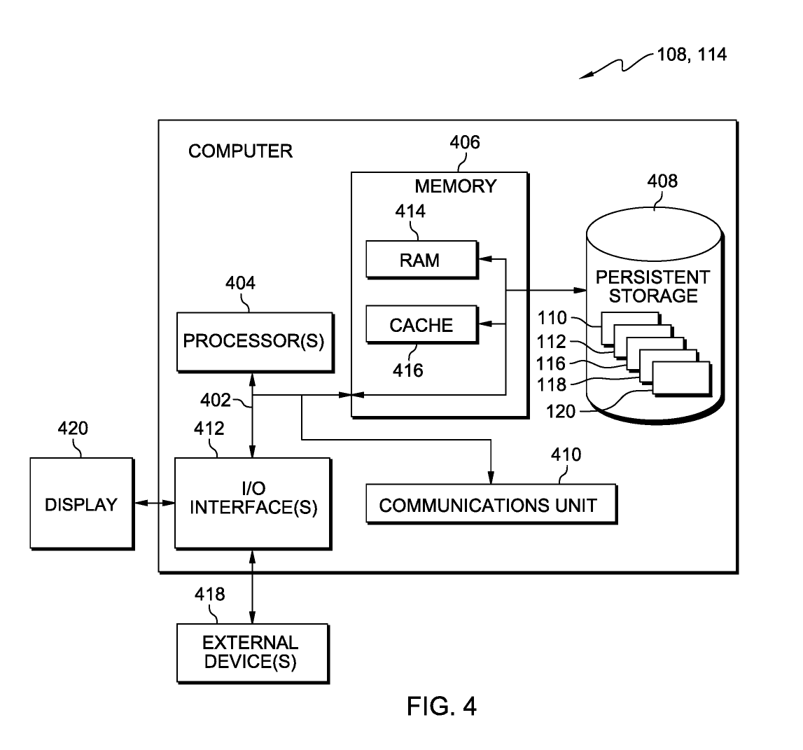

FIG. 4 depicts a block diagram of components of health accessibility configuration server computer 108 or client computing device 114 within distributed data processing environment 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Health accessibility configuration server computer 108 and client computing device 114 can each include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 414 and cache memory 416. In general, memory 406 can include any suitable volatile or non-volatile computer readable storage media.

Accessibility configuration database 110 and settings recommendation program 112 are stored in persistent storage 408 for execution and/or access by one or more of the respective computer processor(s) 404 of health accessibility configuration server computer 108 via one or more memories of memory 406. User interface 116, health accessibility configuration program 118, and database 120 are stored in persistent storage 408 for execution and/or access by one or more of the respective computer processor(s) 404 of client computing device 114 via one or more memories of memory 406. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of health provider server computer 104 and health accessibility configuration server computer 108. In these examples, communications unit 410 includes one or more network interface cards. Communications unit 410 may provide communications through the use of either or both physical and wireless communications links. Accessibility configuration database 110 and settings recommendation program 112 may be downloaded to persistent storage 408 of health accessibility configuration server computer 108 through communications unit 410. User interface 116, health accessibility configuration program 118, and database 120 may be downloaded to persistent storage 408 of client computing device 114 through communications unit 410.

I/O interface(s) 412 allows for input and output of data with other devices that may be connected to health accessibility configuration server computer 108 and client computing device 114. For example, I/O interface(s) 412 may provide a connection to external device(s) 418 such as a keyboard, a keypad, a touch screen, a microphone, and/or some other suitable input device. External device(s) 418 can also include portable computer readable storage media such as, for example, thumb drives, portable optical or magnetic disks, and memory cards. Software and data used to practice embodiments of the present invention, e.g., accessibility configuration database 110 and settings recommendation program 112 on health accessibility configuration server computer 108, can be stored on such portable computer readable storage media and can be loaded onto persistent storage 408 of health accessibility configuration server computer 108 via I/O interface(s) 412. Software and data used to practice embodiments of the present invention, e.g., user interface 116, health accessibility configuration program 118, and database 120 on client computing device 114, can be stored on such portable computer readable storage media and can be loaded onto persistent storage 408 of client computing device 114 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for configuring accessibility settings on an electronic device, the method comprising:
receiving, by one or more computer processors, a first electronic data including at least one medical change made to an electronic medical record corresponding to a user, wherein the electronic medical record is stored on a second computing device, and wherein the at least one medical change includes at least one of: a medical diagnosis of a medical condition, a temporary physical change, a prescription of a medication with associated side effects, or one or more laboratory test results;
determining, by the one or more computer processors, at least one accessibility settings recommendation for an electronic device of the user, based, at least in part, on the received first electronic data, wherein accessibility settings are any feature of a computing system of an electronic device that allows a modification of a user interface of the computing system and enables a user with a physical limitation to improve an ability to use the electronic device;
receiving, by the one or more computer processors, a unique identifier of the user;
sending, by the one or more computer processors, a second electronic data comprising the at least one accessibility settings recommendation to the electronic device of the user;
determining, by one or more computer processors, current accessibility settings of the electronic device;
calculating, by the one or more computer processors, a difference between the current accessibility settings of the electronic device and the at least one accessibility settings recommendation;
determining, by the one or more computer processors, whether the difference between the current accessibility settings of the electronic device and the at least one accessibility settings recommendation meets a target value;
responsive to determining the difference between current accessibility settings of the electronic device and the at least one accessibility settings recommendation does not meet a target value, configuring, by the one or more computer processors, the electronic device with the at least one accessibility settings recommendation, wherein configuring the electronic device with the at least one accessibility settings recommendation includes configuring incremental changes to the accessibility settings;
responsive to configuring the at least one accessibility settings recommendation, querying, by the one or more computer processors, the user for acceptance of the configuration; and
responsive to receiving an acceptance of the query from the user, maintaining, by the one or more computer processors, the at least one accessibility setting recommendation configuration.
